(19) United States
(12) Patent Application Publication
(10) Pub. No.: US 2014/0133353 A1
(43) Pub. Date: May 15, 2014

(54) COMMUNICATION DEVICE, METHOD FOR DETECTING HUB AND TRANSMITTING PACKET THEREOF

(71) Applicants: Sangsu Jung, Daejeon (KR); Boram Jin, Incheon (KR); Okyu Kwon, Daejeon (KR)

(72) Inventors: Sangsu Jung, Daejeon (KR); Boram Jin, Incheon (KR); Okyu Kwon, Daejeon (KR)

(73) Assignee: NATIONAL INSTITUTE FOR MATHEMATICAL SCIENCES, Daejeon (KR)

(21) Appl. No.: 14/126,487

(22) PCT Filed: Jul. 13, 2011
(86) PCT No.: PCT/KR2011/005144

§ 371 Date: Dec. 16, 2013

(30) Foreign Application Priority Data
Jun. 24, 2011 (KR) 10-2011-0061767

(51) Int. Cl. H04L 12/751; H04L 12/721

(52) U.S. Cl. CPC H04L 45/026; H04L 45/44
USPC 370/254

(57) ABSTRACT

A communication device operating as a node constituting a multi-hop network in which a plurality of different networks are mixed, a method for detecting a hub, and a method for transmitting a packet are provided. The communication device includes: a hub detection unit configured to determine whether or not the communication device operates as a hub; a pheromone calculation unit configured to calculate a pheromone value according to whether or not the communication device is a hub; a transmission unit configured to broadcast the pheromone value to neighbor nodes; a reception unit configured to receive the pheromone value from each of the neighbor nodes; and a forwarding node selecting unit configured to compare the pheromone values of the neighbor nodes and select a neighbor node having the greatest pheromone value as a forwarding node to which a packet is to be transmitted.

### TECHNICAL FIELD

The present invention relates to a communication device, a method for detecting a hub, and a method for transmitting a packet, and more particularly, to a communication device for transmitting a packet to a selected forwarding node by using an ant colony algorithm in a multi-hop network, a method for detecting a hub, and a method for transmitting a packet.

The present invention is derived from research supported by NAP of Korea Research Council of Fundamental Science & Technology.

### BACKGROUND ART

An ant colony algorithm is a routing method based upon such recognition that ants use the shortest distance when seeking food and share information with each other by emitting pheromone up to a destination. The related art ant colony algorithm is advantageous in that the shortest path can be sought in an autonomous manner without such control overhead as in a flooding scheme but disadvantageous in that it causes congestion of a particular area.

Meanwhile, an online social network, which is based on a wired network, has characteristics in that mobility is scarce and communication is performed based on data stored in servers of service providers, so the users role is not large in transferring data.

In comparison, a data transmission of a mobile social network is made based on information stored in user personal terminal, so the role of users is of relatively great importance. Here, the mobile social network refers to a network in which users of mobile portable communication terminals such as smartphones, tablets PCs, or the like, form a community through a social application according to common interests of individuals or groups to exchange data.

Currently, one-hop communication through a cellular network, a wireless (Wi-Fi) network, a Bluetooth network, or the like, is the mainstream, but, in the future, it is highly like to be reorganized into a structure in which terminals establish an ad-hoc network through radio communication and a data transmission is made through a multi-hop of a heterogeneous network including the ad-hoc network. This will advantageously lessen data explosion because resources of the cellular network and the wireless (Wi-Fi) network occupied by the users of the smartphones and tablet PCs that are currently sharply increasing can be considerably reduced.

Also, a social network is known as a scale-free network. Thus, a hub which is connected with a large number of different nodes, compared with general nodes, exist in the social network. Such a hub is frequently selected as a transmission path of the shortest path routing and has characteristics in that data can be transferred in various directions.

Meanwhile, in the related art communication network, in order to search for a hub, betweenness centrality must be measured based on information regarding an overall topology. However, there is a difficulty in detecting a hub due to an absence of a central management system, discontinuity of a wireless network connection, or the like. In addition, a hub may cause traffic congestion due to relatively frequent connections and may be utilized as a propagation means such as virus, warm, or the like.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a communication device, a method for detecting a hub, and a method for transmitting a packet having advantages of detecting a hub in such a distributed manner that a central control system is not required, and reducing the frequency of use of a path with respect to the hub.

### Solution to Problem

An exemplary embodiment of the present invention provides a communication device. The communication device operating as a node constituting a multi-hop network in which a plurality of different networks are mixed, includes: a hub detection unit configured to determine whether or not the communication device is a hub; a pheromone calculation unit configured to calculate a pheromone value according to whether or not the communication device is a hub; a transmission unit configured to broadcast the pheromone value to neighbor nodes; a reception unit configured to receive the pheromone value from each of the neighbor nodes; and a forwarding node selecting unit configured to compare the pheromone values of the neighbor nodes and select a neighbor node having the greatest pheromone value as a forwarding node to which a packet is to be transmitted.

Another embodiment of the present invention provides a method for detecting a hub. The method includes: storing, by a certain node constituting a multi-hop network in which a plurality of different networks are mixed, a source address and a destination address of packets which have passed through the certain node; receiving location information, a pheromone value, and path utilization frequency of each of one-hop neighbor nodes from the one-hop neighbor nodes; determining whether or not the one-hop neighbor nodes are problematic nodes based on received signal strength, the location information, and the pheromone value of each of the one-hop neighbor nodes; and determining whether or not the certain node itself is a hub by comparing path utilization frequency of a one-hop neighbor node which is not a problematic node with path utilization frequency of the certain node.

Yet another embodiment of the present invention provides a method for transmitting a packet. The method for transmitting a packet by a node constituting a multi-hop network in which a plurality of different networks are mixed, includes: whether or not the node is a hub; calculating a pheromone value according to whether or not the node is a hub; exchanging the pheromone value with neighbor nodes; comparing pheromone values received from the neighbor nodes; and transmitting a packet to a neighbor node having the greatest pheromone value.

### Advantageous Effects of Invention

According to an embodiment of the present invention, since the method for assigning pheromone is provided to detect a hub and prevent the hub from being overly included in a routing path, a congestion in the area around the hub can be prevented and a degradation of performance of an overall network when the hub has a problem due to an attack, an intrusion, a failure, or the like, can be minimized.

Also, since a hub is detected by using path utilization frequency based on the number of hops through which a packet has passed, a source address, and a destination address in a mobile social network, only information regarding the node itself and neighbor nodes is utilized, so overhead with respect to overall topology information exchange can be reduced.

In addition, in the method for detecting a hub may be utilized for effectively detecting a hub in a hub-and-spoke type network such as a scale-free network, a wireless mesh network, a wireless sensor network, or the like.

Moreover, since effective communication is selected according to a channel status and a billing policy of several communications and a pheromone value is calculated according to a movement speed of a neighbor node and whether or not a corresponding node is a hub, an optimum service can be provided in the process of transmitting data.

Furthermore, usage frequency of a hub can be appropriately adjusted by controlling a pheromone value of the hub, and a traffic congestion around the hub can be resolved. Thus, the influence of a hub, which is infected by a virus, worm, or the like, so as to be utilized as a propagation means, or the influence of a hub when the hub has a problem such as a failure, an attack, or the like, on the overall network performance can be minimized.

### BRIEF DESCRIPTION OF DRAWINGS

FIG. 1 is a view showing a network configuration to which an embodiment of the present invention is applied.

FIG. 2 is a schematic block diagram of a communication device according to an embodiment of the present invention.

FIG. 3 is a view showing the structure of an FIB according to an embodiment of the present invention.

FIG. 4 is a view showing a basic structure of a hello message according to an embodiment of the present invention.

FIG. 5 is a table of average time to live (TTL) values according to an embodiment of the present invention.

FIG. 6 is a table of a pheromone evaporation rate with respect to a communication method according to an embodiment of the present invention.

FIG. 7 is a parameter configuration table according to an embodiment of the present invention.

FIG. 8 is a flow chart illustrating a process of a packet transmission method according to an embodiment of the present invention.

FIG. 9 is a flow chart illustrating a process of a method for detecting a hub according to an embodiment of the present invention.

FIG. 10 is a flow chart illustrating a process of a method for transmitting a hello message according to an embodiment of the present invention.

FIG. 11 is a flow chart illustrating a process of a method for transmitting a packet of a source node according to an embodiment of the present invention.

FIG. 12 is a flow chart illustrating a process of a method for routing a packet of a forwarding node according to an embodiment of the present invention.

FIG. 13 is a view showing the structure of a mobile social network according to an embodiment of the present invention.

FIG. 14 is a graph showing the comparison between the evaporation rates over the amount of pheromone in the routing method (HDR) according to an embodiment of the present invention and in the conventional ant colony algorithm routing (ARA).

FIG. 15 is a graph showing the comparison between pheromone values over time in the routing method (HDR) according to an embodiment of the present invention and in the conventional ant colony algorithm routing (ARA).

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. In order to clarify the present invention, parts irrespective of description will be omitted, and similar drawing sequences are used for the similar parts throughout the specification.

Throughout the specification, unless explicitly described to the contrary, the word “comprise” and variations such as “comprises” or “comprising”, will be understood to imply the inclusion of stated elements but not the exclusion of any other elements.

Term of “ . . . part” described in the specification refers to a unit for processing at least one function or operation, and it may be implemented by hardware, software, or a combination of hardware and software.

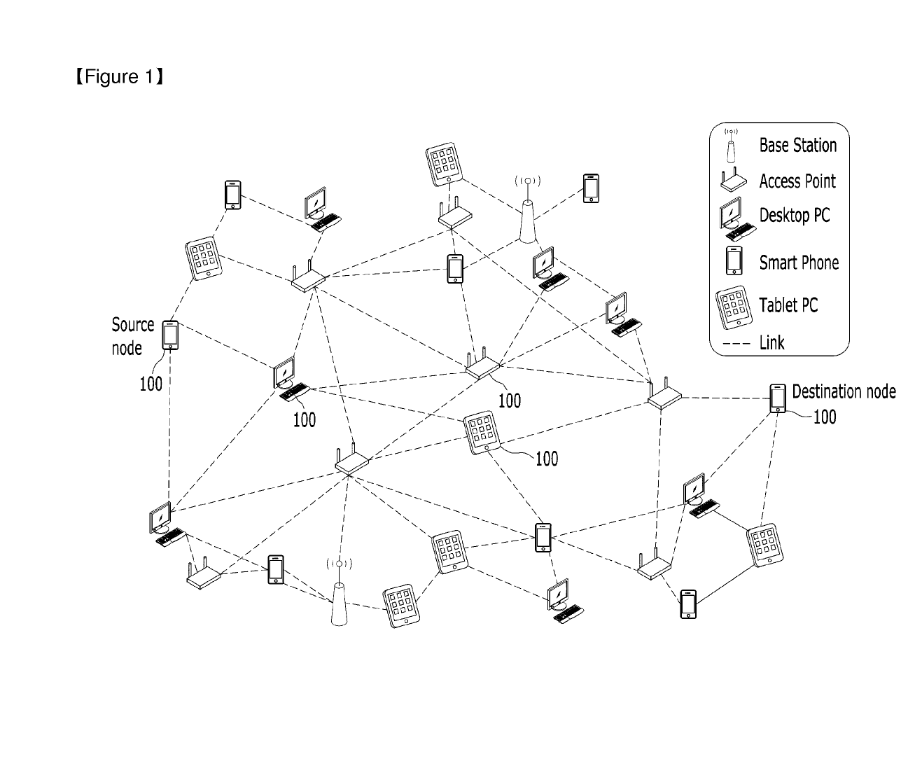

FIG. 1 is a view showing a network configuration to which an embodiment of the present invention is applied.

With reference to FIG. 1, a network to which an embodiment of the present invention is applied may be defined as a mobile social network based on a social community formed according to particular interests.

Here, in the mobile social network, a data transmission is made based on information stored in user personal information, so the users role is given a great deal of weight. Namely, the mobile social network refers to a network in which users of mobile portable communication terminals such as smartphones, tablet PCs, or the like, form a community through a social application according to common interests of individuals or groups to exchange data.

Such a social network is implemented as an ad-hoc multi-hop network including one or more nodes and a set of links existing between two nodes.

Here, each node is a constituent element constituting the multi-hop network, and includes a base station, an access point, a desktop PC, a smartphone, a tablet PC, or the like. Here, the node having mobility, such as a smartphone, a table PC, or the like, is particularly called a mobile node.

The multi-hop network is a network in which a plurality of heterogeneous networks are mixed. In the multi-hop network, a desktop PC connected to a weird network or a wireless network, a plurality of access points providing a wireless (Wi-Fi) network service, a plurality of base stations (BSs) providing a cellular network service exist as a single node present on a communication path. Namely, nodes providing different communication schemes form different links to transmit and receive packets.

Also, information regarding a neighbor node can be known by transmitting and receiving a hello message. Namely, when a node wants to inform about its existence, the node may periodically transmit a hello message to a one-hop neighbor node.

For example, when a source node 100 transmits a packet to a destination node 100′ a desktop PC, an access point, and a tablet PC exist on a packet transmission path, and the packet is transmitted to the final destination node 100′ through such multi-hop. Here, the source node 100 and the destination node 100′ are all smartphones.

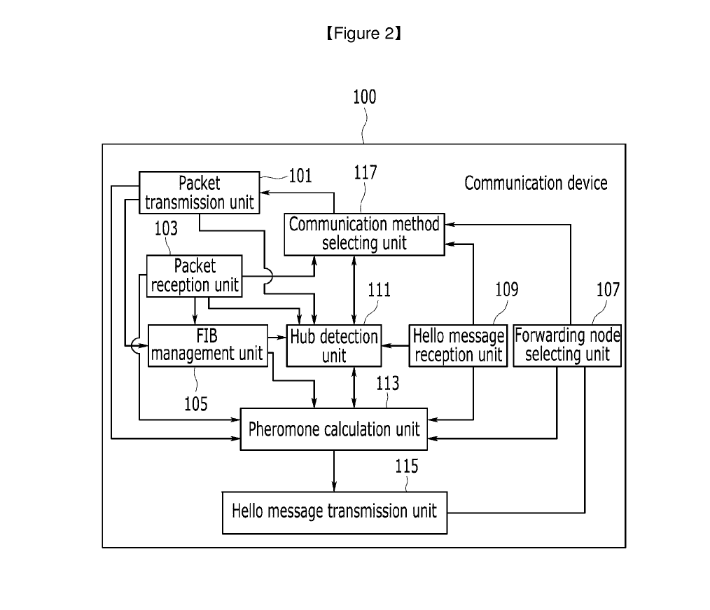

Here, all the nodes will be generally called a communication device 100, and the communication device 100 is configured as shown in FIG. 2.

FIG. 2 is a schematic block diagram of the communication device according to an embodiment of the present invention.

The communication device 100 includes constituent elements each performing a unique function according to whether they are a mobile node, a base station, and an access point. In FIG. 2, only the common function according to an embodiment of the present invention is illustrated.

With reference to FIG. 2, the communication device 100 includes a packet transmission unit 101, a packet reception unit 103, an FIB (Forwarding Information Base) management unit 105, a communication method selecting unit 107, a hello message reception unit 109, a hub detection unit 111, a pheromone calculation unit 113, a hello message transmission unit 115, and a forwarding node selecting unit 117.

The packet transmission unit 101 transmits a packet to a one-hop neighbor node selected as a forwarding node by the forwarding node selecting unit 117. In this case, the packet transmission unit 101 transmits a packet having a set TTL (Time-To-Live) value.

Here, the TTL value is reduced by 1 each time whenever the packet is hopped to a different node, and the packet is hopped to a different node until such time as the TTL value becomes 0. For example, when a node receives the packet from the source node, it reduces the TTL value by 1 and hops it to a neighbor node.

The packet reception unit 103 receives the packet from the source node or a certain one-hop neighbor node.

The FIB management unit 105 updates an FIB including routing table information whenever the packet is transmitted or received through the packet transmission u nit 101 and the packet reception unit 103. Namely, the FIB management unit 105 stores a source address and a destination address of packets which have passed therethorugh.

The communication method selecting unit 107 selects an appropriate communication method according to a channel status and a billing policy from among communication using a cellular network base station communication using a wireless network access point, and direct communication through neighbor nodes.

The communication method selecting unit 107 includes a user interface for requesting a user to select an access network from among a plurality of networks and receiving a selected network when the user wants a data connection.

Also, when a communication method of the communication device 100 is fixed like a base station, an access point, or the like, the communication method selecting unit 107 selects a communication method set as a default.

The hello message reception unit 109 periodically receives hello messages from one-hop neighbor nodes. The hello message includes location information of the corresponding neighbor nodes, a movement speed, a path utilization frequency, a pheromone value, and a communication method.

The hub detection unit 111 determines whether or not a certain one-hop neighbor node is a problematic node based on location information, received signal strength, and a pheromone value checked through the hello messages from the one-hop neighbor nodes received through the hello message reception unit 109, and excludes a one-hop neighbor node determined to be a problematic node. And, the hub detection unit 111 compares the path utilization frequency and the pheromone value of the communication device 100 with those of one-hop neighbor nodes, not a problematic node, in order to determine whether or not the communication device 100 is a hub.

In detail, the hub detection unit 111 determines whether or not received signal strength of each of hello messages received by the hello message reception unit 109 from one-hop neighbor nodes satisfies a certain strength and whether or not a link connection duration (tᵢⱼ) satisfies a predefined threshold value.

Here, in order to minimize the influence of mobility of each of the mobile nodes (i), the hub detection unit 111 estimates a link connection duration (tᵢⱼ) by using location information (xⱼ, yⱼ) a relative movement speed (vₓ, v_{y}), a transmission range (d) of each of the mobile nodes (i), as represented by Equation 1 shown below.

$${t}_{ij} = \frac{- ( {v}_{x} {r}_{x} + {v}_{y} {r}_{y} ) + \sqrt{( {v}_{x}^{2} + {v}_{y}^{2} ) {d}^{2} - {( {v}_{x} {r}_{y} - {v}_{y} {r}_{x} )}^{2}}}{{v}_{x}^{2} + {v}_{y}^{2}} \qquad ( Equation 1 )$$

Here, vₓ, v_{y} are relative movement speeds in an x axis direction and y axis direction of one-hop neighbor node (j) with respect to each of the mobile nodes (i), respectively.

rₓ, r_{y} are relative coordinates of x axis and y axis of one-hop neighbor node (i).

Also, the hub detection unit 111 calculates its path utilization frequency based on location information and pheromone values checked through the hello messages from the one-hop neighbor nodes whose received signal strength satisfies a certain strength and link connection duration (tᵢⱼ) satisfies the predefined threshold value, and a source address and a destination address stored in the FIB. And, the hub detection unit 111 compares the calculated path utilization frequency of its own with path utilization frequency included in the hello messages of the one-hop neighbor nodes, and when its path utilization frequency is greater and the TTL of a transmission and reception packets satisfies an average TTL condition, the hub detection unit 111 recognizes that the communication device 100 is a hub.

When the communication device 110 is a mobile node, the pheromone calculation unit 113 calculates its relative movement speed based on the movement of one-hop neighbor node, and calculates a pheromone value according to whether or not the hub detection unit 111 detects that communication device 100 is a hub. Here, the pheromone calculation unit 113 updates the pheromone value each time a packet is transmitted or received.

Here, the pheromone value is calculated through Equation 2 shown below.

P_{id}(t+1)=(1−ρ_{M})P_{id}(t)+e^{-KP}^{_{id}}^{(t)}P_{id}(t)+Δτ_{id} (Equation 2)

Here, P_{id}(t+1) is a pheromone value corresponding to a destination node d of each node i at a point in time t+1 calculated based on a pheromone value corresponding to the destination node d of each node i at a point in time t. The method for calculating such a pheromone value follows the conventional ant colony algorithm.

ρ_{M} is a pheromone evaporation rate with respect to a cellular network, a wireless (Wi-Fi) network, and a mobile terminal.

e^{-KP}^{_{id}}^{(t)} an evaporation rate according to a pheromone value of each node. Here, K has various values according to whether or not the communication device 100 is a hub and path utilization frequency of the hub.

In this manner, as the pheromone values are continuously updated in each of the nodes according to Equation 2, a stable routing path can be secured.

The hello message transmission unit 115 includes the pheromone value calculated by the pheromone calculation unit 113 and the communication method selected by the communication method selecting unit 107 in a hello message, and periodically broadcasts the hello message to the one-hop neighbor nodes.

The forwarding node selecting unit 117 selects one-hop neighbor nodes, whose link connection duration estimated by the hub detection unit 111 satisfies the predefined reference value, among one-hop neighbor nodes from which the hello message reception unit 109 has received the hello messages, as targets of forwarding nodes. And then, the forwarding node selecting unit 117 compares pheromone values of the one-hop neighbor nodes selected as targets of forwarding nodes, selects a one-hop neighbor node having the greatest pheromone value as a forwarding node, and informs the packet transmission unit 101 accordingly.

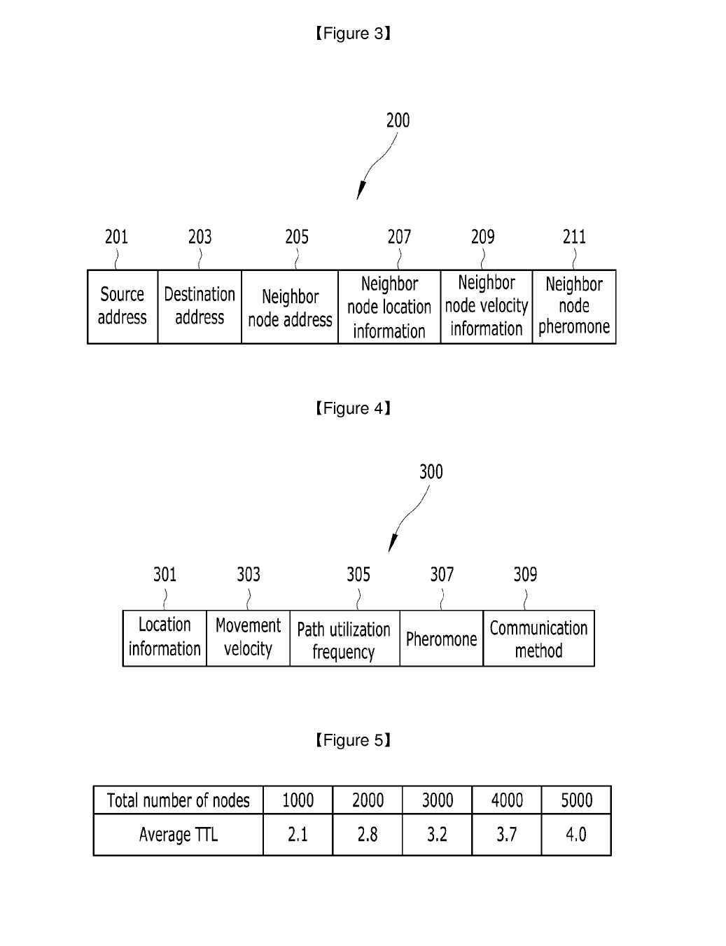

FIG. 3 is a view showing the structure of an FIB according to an embodiment of the present invention.

With reference to FIG. 3, the FIB includes a source address field 201, a destination address field 203, a neighbor node address field 205, a neighbor node location information field 207, a neighbor node speed information field 209, and a neighbor node pheromone field 211.

Here, the source address field 201 includes source addresses of packets which have passed through a corresponding node.

The destination address field 203 includes destination addresses of packets which have passed through a corresponding node.

The neighbor node address field 205 includes neighbor node addresses which may be included in a packet transmission path with respect to the destination addresses included in the destination address field 203.

The neighbor node location information field 207 includes location information regarding a neighbor node included in the neighbor node address field 205.

The neighbor node speed information field 209 includes velocity information regarding a neighbor node included in the neighbor node address field 205.

The neighbor node pheromone field 211 includes pheromone values of respective neighbor nodes included in the neighbor node address field 205.

FIG. 4 is a view showing a basic structure of a hello message according to an embodiment of the present invention.

With reference to FIG. 4, a hello message 300 transmitted or received by the hello message reception unit 109 and the hello message transmission unit 115 includes a location information field, 301, a movement speed field 303, a path utilization frequency field 305, a pheromone field 307, and a communication method field 309.

The location information field 301 includes location information of a corresponding node.

The movement speed field 303 includes a movement speed of a corresponding node.

The path utilization frequency field 305 includes path utilization frequency of a corresponding node.

The pheromone field 307 includes a pheromone value of a corresponding node.

The communication method field 309 includes a communication method of a corresponding node. Here, when a corresponding node is a base station or an access point, a default communication method may be set for the base station or the access point, respectively. Namely, when the corresponding node is a base station, a cellular network is set as a default communication method, when the corresponding node is an access point, a wireless LAN is set as a default communication method, and when the corresponding node is a desktop PC, a wired network is set as the default communication method. Also, when the corresponding node is a mobile node, a communication method selected by the user from among accessible communication schemes may be set.

FIG. 5 is a table of average TTL values according to an embodiment of the present invention.

With reference to FIG. 5, examples of average time to line (TTL) values of a packet introduced to a hub in a scale-free network can be checked.

Here, the average TTL values may change according to mobility, a connection configuration, and the number of nodes of a network. Namely, when the total number of nodes is 1,000, an average TTL is 2.1, when the total number of nodes is 2,000, an average TTL is 2.8, when the total number of nodes is 3,000, an average TTL is 3.2, when the total number of nodes is 4,000, an average TTL is 3.7, and when the total number of nodes is 5,000, an average TTL is 4.0.

Thus, the hub detection unit 111 of FIG. 2 determines whether or not the communication device 100 is a hub based on an average TTL which corresponds with a network to which the communication device 100 belongs in the table of average TTL.

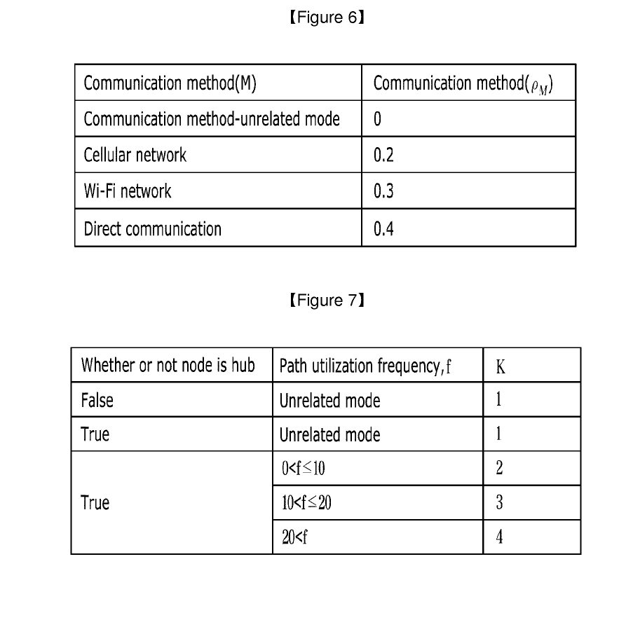

FIG. 6 is a table of a pheromone evaporation rate with respect to a communication method according to an embodiment of the present invention.

With reference to FIG. 6, when the communication device 100 operates in a communication method-unrelated mode, a pheromone evaporation rate (ρ_{M}) is 0.

Also, when the communication method of the communication device 100 is a cellular ρ_{M}) is 0.2.

When the communication method of the communication device 100 is a wireless (Wi-Fi) network, the pheromone evaporation rate (ρ_{M}) is 0.3.

When the communication method of the communication device 100 is direct communication between devices, the pheromone evaporation rate (ρ_{M}) is 0.4.

Thus, the pheromone calculation unit 113 of FIG. 2 calculates a pheromone value by applying the pheromone evaporation rate (ρ_{M}) corresponding to a communication method selected by the communication method selecting unit 107 from among the pheromone evaporation rates (ρ_{M}).

FIG. 7 is a parameter configuration table according to whether or not a node is a hub and path utilization frequency of the node according to an embodiment of the present invention.

With reference to FIG. 7, in the parameter configuration table, when path utilization frequency (f) is set as an unrelated mode, the parameter K is mapped as 1, irrespective whether or not a node is a hub is false or true.

Also, in case in which whether or not a node is a hub is true, when 0<path utilization frequency (f)≦10, the parameter K is mapped as 2.

Also, in case in which whether or not a node is a hub is true, when 0<path utilization frequency (f)≦20, the parameter K is mapped as 3.

Also, in case in which whether or not a node is a hub is true, when 20<path utilization frequency (f), the parameter K is mapped as 4.

Thus, the pheromone calculation unit 113 of FIG. 2 calculates a pheromone value by applying the hub determination results of the hub detection unit 111 of FIG. 2 and the parameter K corresponding to the path utilization frequency (f) calculated by the hub detection unit 111 selected from the parameter configuration table to Equation 2.

A method for detecting a hub and a method for transmitting a packet of the communication device 100 according to an embodiment of the present invention will now be described.

Here, the same reference numerals will be used in association with the constituent elements of FIGS. 2 to 7 in the following description.

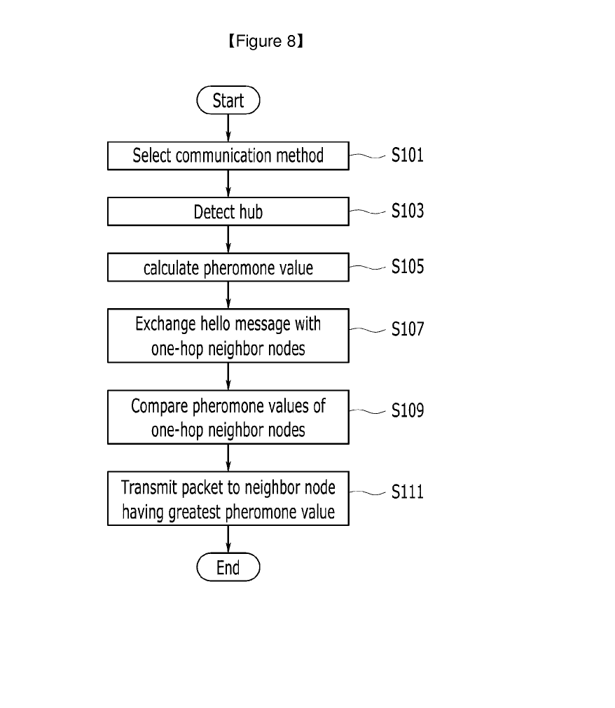

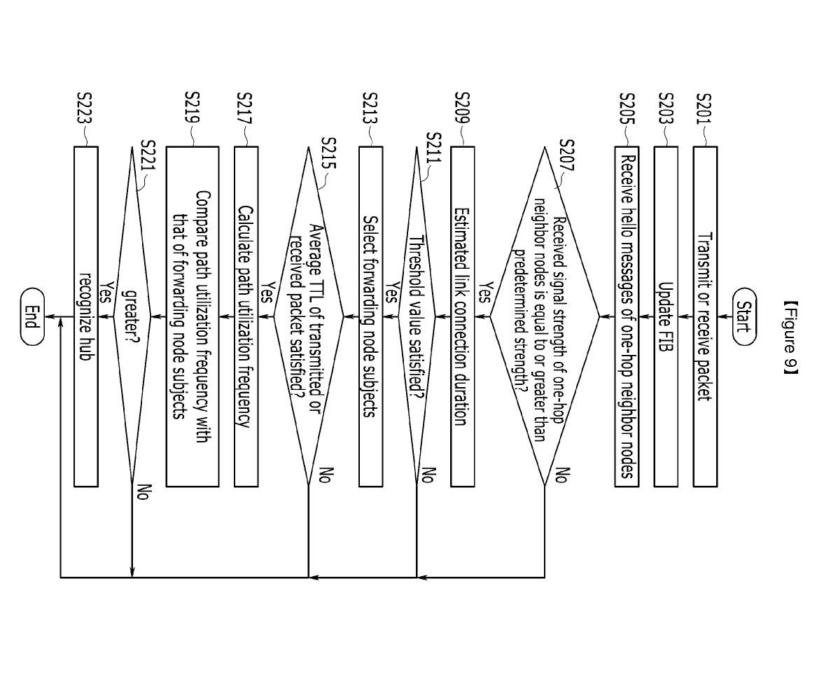

FIG. 8 is a flow chart illustrating a process of a packet transmission method according to an embodiment of the present invention.

Here, a packet transmission includes both an operation of first transmitting, by a source node, a packet, and an operation of routing, by a forwarding node positioned between the source node and a destination node, the packet.

With reference to FIG. 8, the communication method selecting unit 107 of the communication device 100 operating as a certain node (including a source node or a forwarding node) selects a communication method (S101).

Here, step S101 is performed when the communication device 100 is a mobile node. This step may be omitted when the communication device 100 is a base station, an access point, or a desktop PC, because the communication method is fixed such that it cannot be selected.

Next, the hub detection unit 111 of the communication device 100 determines whether or not the communication device 100 is a hub having high path utilization frequency (S103). A detailed process will be described later with reference to FIG. 4.

And then, the pheromone calculation unit 113 of the communication device 100 calculates a pheromone value by using Equation 2 according to the communication method selected in step S101 or a communication method set as a default, and according to whether or not the communication device 100 is a hub having high path utilization frequency as detected in step S103 (S105). Namely, when the communication device 100 is detected as a hub in step S103, a pheromone value is calculated by applying K selected from the parameter configuration table of FIG. 7.

Thereafter, the hello message transmission unit 115 of the communication device 100 broadcasts a hello message including the pheromone value calculated in step S105 to one-hop neighbor nodes, and the hello message reception unit 109 receives hello messages from the one-hop neighbor nodes, respectively (S107).

Here, the operation of broadcasting the hello message and the operation of receiving the hello messages may be simultaneously performed or separately performed.

And then, the forwarding node selecting unit 117 of the communication device 100 compares pheromone values of the one-hop neighbor nodes based on the hello messages received in step S107 (S 109) and transmits a packet to a neighbor node having the greatest pheromone value (5111).

Here, in case of a node operating as a hub among the one-hop neighbor nodes, the fact that the node is a hub is reflected in the pheromone value, so the node has a lower pheromone value than that of other neighbor nodes, and thus, it is not selected as a node for a packet transmission, resulting in a reduction of the path utilization frequency of the hub.

FIG. 9 is a flow chart illustrating a process of a method for detecting a hub according to an embodiment of the present invention.

With reference to FIG. 9, when a packet transmission and reception is made through the packet transmission unit 101 and the packet reception unit 103 of the communication device 100, the FIB management unit 105 updates the FIB according to the packet transmission and reception (S203). Namely, the FIB management unit 105 updates a source address and a destination address of a transmitted or received packet, an address of a neighbor node which may be included in the packet transmission path with respect to each destination address, location information regarding a neighbor node, velocity information, and pheromone of each neighbor node in the FIB.

Thereafter, the hub detection unit 111 of the communication device 100 determines whether or not the received signal strength of each of the hello messages received by the hello message reception unit 109 from the one-hop neighbor nodes (S205) is equal to or greater than a predetermined strength (S207). This step is to exclude neighbor nodes in an unstable state from an intention determination process.

Next, the hub detection unit 111 estimates a link connection duration (tᵢⱼ) of each of the one-hop neighbor nodes whose received signal strength is determined to be equal to or greater than the predetermined strength (S209) to determine whether or not the link connection duration (tᵢⱼ) satisfies a predefined threshold value (S211).

Here, one-hop neighbor nodes satisfying the predetermined threshold value are selected as forwarding node subjects (or targets) (S213).

Here, the process of estimating a link connection duration may be omitted in an environment in which mobility is scarce.

Then, the hub detection unit 111 determines whether or not a TTL of the transmitted or received packet satisfies an average TTL condition (S215). Here, the TTL of the transmitted or received packet is included in the transmitted or received packet.

Also, the average TTL may change according to mobility, a connection configuration, or the number of nodes of a network, and it may be previously stored or may be calculated periodically.

For example, as the average TTL condition, an average TTL condition mapped to a network to which the communication device 100 itself belongs in the values of FIG. 5 may be used.

Here, when the average TTL condition is met in step S215, the hub detection unit 111 calculates path utilization frequency of the node itself based on the information included in the FIB which was updated in step S203 (S217).

And, the hub detection unit 111 compares the calculated path utilization frequency with the path utilization frequency included in each of the hello messages received from the one-hop neighbor nodes (S205) selected as forwarding node subjects in step S213 and determine whether or not the calculated path utilization frequency is greater (S221).

When the path utilization frequency calculated in step S217 is greater than each path utilization frequency received in step S205, the communication device 100 determines that it is a hub (S223).

Here, when the mobile social network does not meet the reference of the scale-free network, step S215 is omitted and the next step S217 may be performed.

In this manner, whether or not the communication device 100 is a hub or not may be detected by simply utilizing area information without betweenness centrality information based on the overall topology information in the mobile social network.

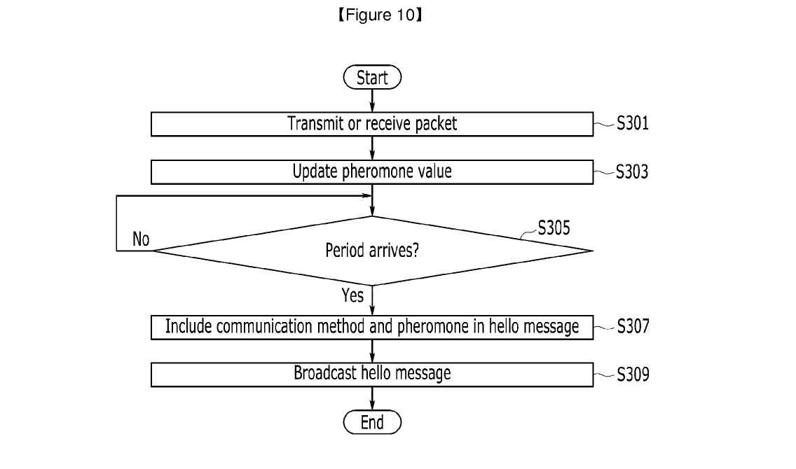

FIG. 10 is a flow chart illustrating a process of a method for transmitting a hello message according to an embodiment of the present invention.

With reference to FIG. 10, when a packet transmission reception is made through the packet transmission unit 101 and the packet reception unit 103 of the communication device 100 (S301), the pheromone calculation unit 113 updates a pheromone value according to a communication method, whether or not the communication device 100 is a hub, and path utilization frequency of the communication device 100 (S303). In this case, the pheromone calculation unit 113 calculates a pheromone value by applying a pheromone evaporation rate according to a corresponding communication method in FIG. 6 thereto.

Thereafter, when a period arrives (S305), the hello message transmission unit 115 of the communication device 100 includes the communication method and the pheromone value updated in step S303 in a hello message and broadcasts the same to the one-hop neighbor nodes (S309).

Also, the method for transmitting a packet according to an embodiment of the present invention will be described by dividing it into a process in which a source node transmits a packet and a process in which a forwarding node routes the packet.

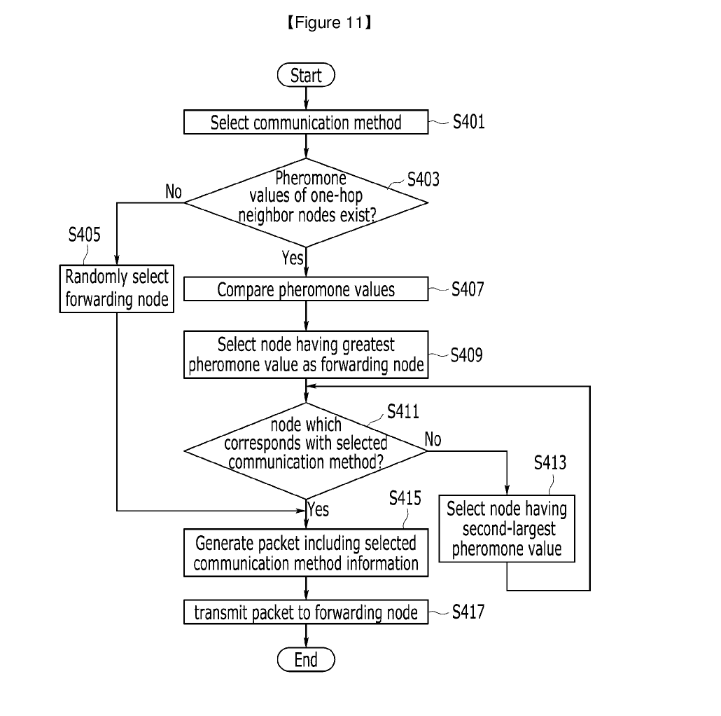

FIG. 11 is a flow chart illustrating a process of a method for transmitting a packet of a source node according to an embodiment of the present invention. Specifically, FIG. 11 is a flow chart illustrating a process of transmitting a packet when the communication device 100 operates as a source node.

With reference to FIG. 11, in a state in which a communication method is selected by the communication method selecting unit 107 of the communication device 100 (S401), the forwarding node selecting unit 117 determines whether or not there are pheromone values which have been received from one-hop neighbor nodes (S403).

Here, the forwarding node selecting unit 117 selects one-hop neighbor nodes whose hello message, which has been received by the hello message reception unit 109, has a received signal strength equal to or greater than a predetermined strength and whose link connection duration satisfies a reference value (or threshold value), as forwarding node subjects, and determines whether or not the selected forwarding node subjects have a pheromone value.

Here, if there is no pheromone information regarding a node like in a network initial stage, the forwarding node selecting unit 117 selects a forwarding node with random probability (S405).

Meanwhile, when there are pheromone values which have been received, the forwarding node selecting unit 117 compares the pheromone values (S407) and selects a one-hop neighbor node having the greatest pheromone value as a forwarding node (S409).

The forwarding node selecting unit 117 then determines whether or not the communication method included in the hello message received from the one-hop neighbor node and the communication method (which is selective or fixed as a default) of the communication device 100 correspond with each other (S411)

Here, when the mutual communication methods do not correspond with each other, the forwarding node selecting unit 117 selects a one-hop neighbor node having the second-greatest pheromone value as a forwarding node (S413), and then performs step S411.

Meanwhile, when the mutual communication methods correspond with each other in step S411, the forwarding node selecting unit 117 includes the communication method of the communication device 100 in a packet (S415).

Then, the packet transmission unit 101 transmits the packet generated in step S415 to the forwarding node selected in step S405 or step S409 (S417).

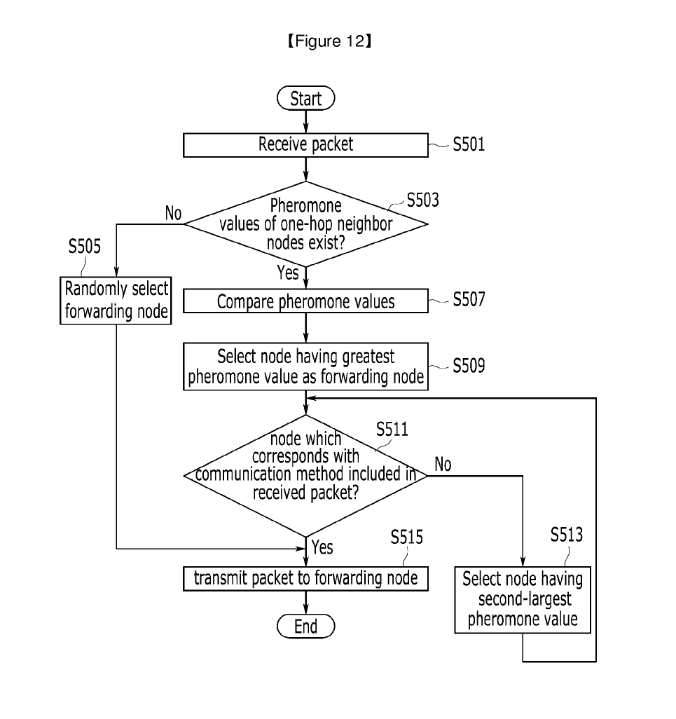

FIG. 12 is a flow chart illustrating a process of a method for routing a packet of a forwarding node according to an embodiment of the present invention. Specifically, FIG. 12 is a flow chart illustrating a process of routing a packet when the communication device 100 operates as a forwarding node.

With reference to FIG. 12, when the packet reception unit 103 of the communication device 100 receives a packet (S501), the forwarding node selecting unit 117 determines whether or not there are pheromone values which have been received from one-hop neighbor nodes (S503). Here, a received packet includes a communication method included by a source node.

Also, the forwarding node selecting unit 117 selects one-hop neighbor nodes whose hello message, which has been received by the hello message reception unit 109, has a received signal strength equal to or greater than a predetermined strength and whose link connection duration satisfies a reference value (or threshold value), as forwarding node subjects, and determines whether or not the selected forwarding node subjects have a pheromone value.

Here, if there is no pheromone information regarding a node like in a network initial stage, the forwarding node selecting unit 117 selects a forwarding node with random probability (S505).

Meanwhile, when there are pheromone values which have been received, the forwarding node selecting unit 117 compares the pheromone values (S507) and selects a one-hop neighbor node having the greatest pheromone value as a forwarding node (S509).

The forwarding node selecting unit 117 then determines whether or not the communication method included in the received packet and the communication method included in the hello message received from the one-hop neighbor node selected as a forwarding node correspond with each other (S511)

Here, when the mutual communication methods do not correspond with each other, the forwarding node selecting unit 117 selects a one-hop neighbor node having the second-greatest pheromone value as a forwarding node (S513), and then performs step S511.

Meanwhile, when the mutual communication methods correspond with each other in step S511, the packet transmission unit 101 transmits the received packet to the forwarding node selected in step S505 or step S509 (S515).

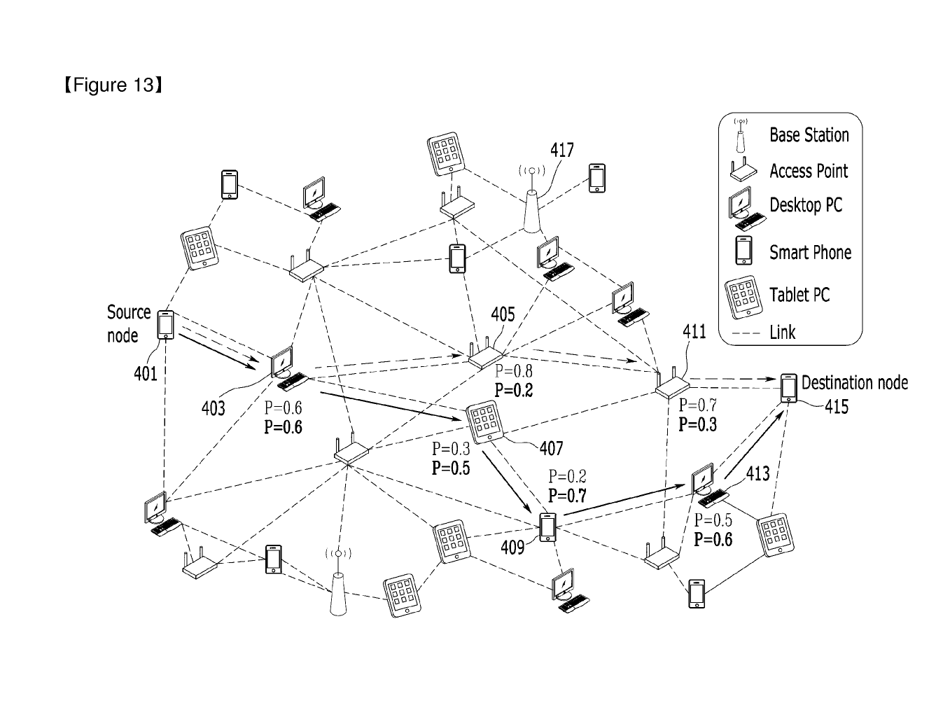

Meanwhile, FIG. 13 is a view showing the structure of a mobile social network in which a packet transmission path is selected based on whether or not a node is a hub and a pheromone value according to an embodiment of the present invention.

With reference to FIG. 13, the mobile social network includes a plurality of mobile nodes including mobile nodes 401, 407, 409, and 415 configured as a smartphone or a tablet PC, a plurality of desktop PCs including desktop PCs 403 and 413 connected to a wired network or a wireless network, a plurality of access points including access points 405 and 411 providing a wireless (Wi-Fi) network service, and a plurality of base stations including a base station 417 providing a cellular network service.

Here, the mobile nodes 401, 407, 409, and 415 and the desktop PCs 403 and 413 transmit and exchange data packets to and with the access points 405 and 411 and the base station 417 through direct communication. A pheromone value is included in order to form a routing path for a packet transmission.

Each of the nodes selects a node having a high pheromone value among its one-hop neighbor nodes, as a forwarding node, and transmits a packet thereto.

Here, in the case of the related art ant colony algorithm routing (ARA), routing is determined based on a pheromone value P for a data transmission between a source node 401 and a destination node 415. Thus, the determined path is 401->403->405->411->415, including the access point 405 as a hub.

Then, the hub is frequently utilized for the routing path, causing a degradation of the overall network performance due to a traffic congestion, a node failure, infection, or the like.

Meanwhile, in case of using the algorithm (i.e., hub detour routing (HDR)) proposed according to an embodiment of the present invention, P′ is assigned as a pheromone value for establishing a path for a data transmission, and a corresponding routing path is 401->403->407->409->413->415. Thus, since the path bypassing the access point 405, i.e., a hub, is selected, the influence of the hub can be adjusted such that it is not excessive.

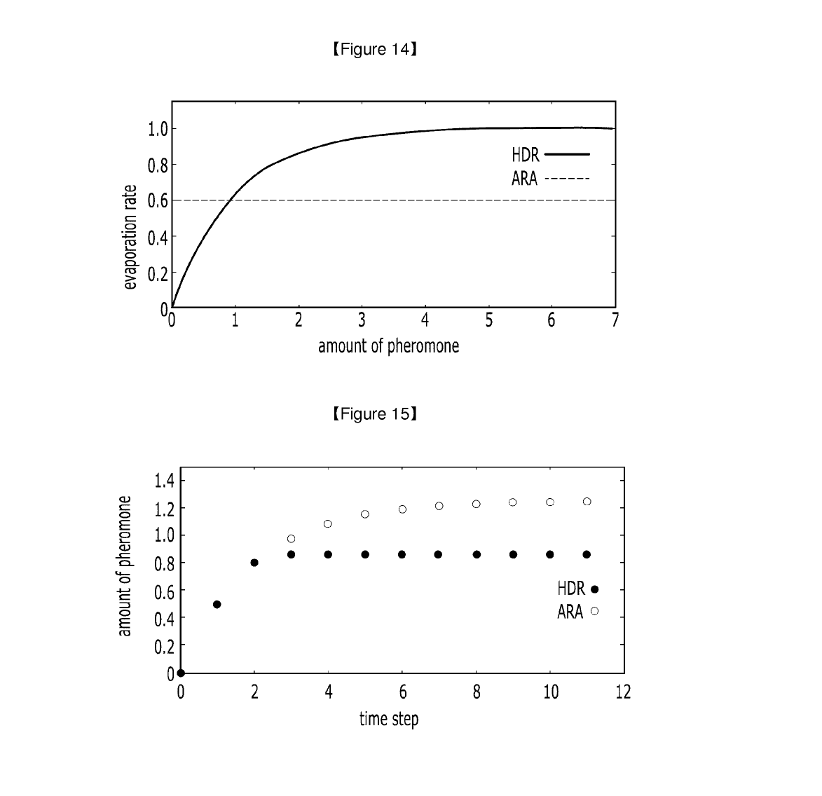

FIG. 14 is a graph showing the comparison between the evaporation rates over the amount of pheromone in the routing method (HDR) according to an embodiment of the present invention and in the conventional ant colony algorithm routing (ARA).

With reference to FIG. 14, in the case of HDR, the evaporation rate is determined by a pheromone value. Namely, the evaporation rate increases at an initial stage in which the pheromone value is small, and it is converged into a uniform value at a certain point in time.

In comparison, in the case of the ARA, the evaporation rate is uniform irrespective of the pheromone value.

FIG. 15 is a graph showing the comparison between pheromone values over time in the routing method (HDR) according to an embodiment of the present invention and in the conventional ant colony algorithm-based routing (ARA).

With reference to FIG. 15, in the case of HDR, the pheromone value is maintained to be uniform on or after a certain point in time. Thus, the pheromone value of the hub which can be frequently utilized can be appropriately adjusted, thus providing an effective and stable path.

In comparison, in the case of ARA, the pheromone value is continuously increased even after a certain point in time. Such characteristics cause an excessive utilization of the hub because the pheromone value of the hub is constantly maintained to have a value greater than that of different nodes.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Also, the embodiments of the present invention may not necessarily be implemented only through the foregoing devices and/or methods but may also be implemented through a program for realizing functions corresponding to the configurations of the embodiments of the present invention, a recording medium including the program, or the like.

1. A communication device operating as a node constituting a multi-hop network in which a plurality of different networks are mixed, the device comprising:
a hub detection unit configured to determine whether or not the communication device is a hub;
a pheromone calculation unit configured to calculate a pheromone value according to whether or not the communication device is a hub;
a transmission unit configured to broadcast the pheromone value to neighbor nodes;
a reception unit configured to receive the pheromone value from each of the neighbor nodes; and
a forwarding node selecting unit configured to compare the pheromone values of the neighbor nodes and select a neighbor node having the greatest pheromone value as a forwarding node to which a packet is to be transmitted.

2. The communication device of claim 1, further comprising:
a management unit configured to update a forwarding information base (FIB) including routing table information whenever a packet is transmitted or received,
wherein the FIB includes a source address and a destination address of a packet which has passed through the communication device, one or more neighbor node addresses included in a packet transmission path with respect to the destination address, location information of the one or more neighbor nodes, velocity information of the one or more neighbor nodes, and pheromone values of the one or more neighbor nodes.

3. The communication device of claim 2, further comprising:
a communication method selecting unit configured to select a communication method of the communication device,
wherein the transmission unit broadcasts a hello message including location information, a movement speed, the path utilization frequency, the pheromone value, and a communication method of the communication device, and
the reception unit receives a hello message including location information, a movement speed, path utilization frequency, a pheromone value, and a communication method of one-hop neighbor node.

4. The communication device of claim 3, wherein the hub detection unit calculates its path utilization frequency by using information stored in the FIB, transmits a hello message whose received signal strength has a predefined strength or greater, compares path utilization frequency of each of one-hop neighbor nodes whose link connection duration satisfies a predefined threshold value with its path utilization frequency, and determines that the communication device is a hub when its path utilization frequency is greater than those of the one-hop neighbor nodes.

5. The communication device of claim 4, wherein the hub detection unit includes a table including an average time to live (TTL) according to network characteristics, selects an average TTL of a network to which the communication device belongs from the table, determines whether or not a TTL of a transmitted or received packet satisfies the selected average TTL, and determines that the communication device is a hub when the TTL of the transmitted or received packet satisfies the selected average TTL.

6. The communication device of claim 4, wherein the pheromone calculation unit stores a table in which respective pheromone evaporation rates are mapped to respective communication methods, a table in which respective parameters are set according to whether or not the communication device is a hub and path utilization frequency, and a pheromone value calculated at a previously point in time, and calculates a pheromone value at a current point in time by using a parameter selected according to the results of determination by the hub detection unit as to whether or not the communication device is a hub and the path utilization frequency, a pheromone evaporation rate selected according to the communication method, and the pheromone value calculated at the previous point in time.

7. The communication device of claim 6, wherein the forwarding node selecting unit selects one-hop neighbor nodes whose hello message has a received signal strength of a predefined certain strength or greater and link connection duration satisfies a threshold value, as forwarding node subjects, and compares pheromone values of the selected forwarding node subjects.

8. The communication device of claim 7, wherein, when the communication device is a source node, the forwarding node selecting unit determines whether or not a communication method of the one-hop neighbor node having the greatest pheromone value corresponds with a communication method selected through the communication method selecting unit, or when the communication device is a forwarding node, the forwarding node selecting unit determines whether or not the communication method of the one-hop neighbor node having the greatest pheromone value corresponds with the communication method included in a reception packet, and when the communication method of the one-hop neighbor node having the greatest pheromone value corresponds with the communication method included in a reception packet, the forwarding node selecting unit performs packet transmission, or otherwise, the forwarding node selecting unit selects a one-hop neighbor node having the second-greatest pheromone value.

9. The communication device of claim 8, further comprising:
a packet transmission unit configured to include a communication method selected by the communication method selecting unit in a packet and transmitting the packet.

10. A method for detecting a hub, the method comprising:
storing, by a certain node constituting a multi-hop network in which a plurality of different networks are mixed, a source address and a destination address of packets which have passed through the certain node;
receiving location information, a pheromone value, and path utilization frequency of each of one-hop neighbor nodes from the one-hop neighbor nodes;
determining whether or not the one-hop neighbor nodes are problematic nodes based on received signal strength, the location information, and the pheromone value of each of the one-hop neighbor nodes; and
determining whether or not the certain node itself is a hub by comparing path utilization frequency of a one-hop neighbor node which is not a problematic node with path utilization frequency of the certain node.

11. The method of claim 10, wherein, in the receiving, a hello message including the location information, the pheromone value, and the path utilization frequency is received.

12. The method of claim 11, wherein the determining of whether or not the one-hop neighbor nodes are problematic nodes comprises:
determining whether or not a received signal strength of the hello message is a predefined signal strength or greater; and
determining that the one-hop neighbor nodes are problematic nodes when the received signal strength of the hello message is smaller than the predefined signal strength.

13. The method of claim 12, wherein the determining of whether or not the certain node itself is a hub comprises;
when the link connection duration with the one-hop neighbor nodes whose received signal strength is the predefined signal strength or greater satisfies a predefined threshold value, comparing the path utilization frequency of the one-hop neighbor nodes with the path utilization frequency of the certain node;
determining whether or not a time to live (TTL) of the transmitted or received packet satisfies a predefined average TTL; and
when the a time to live (TTL) of the transmitted or received packet satisfies a predefined average TTL and the path utilization frequency of the node is greater than that of the one-hop neighbor nodes, determining that the certain node is a hub.

14. A method for transmitting a packet by a node constituting a multi-hop network in which a plurality of different networks are mixed, the method comprising:
whether or not the node is a hub;
calculating a pheromone value according to whether or not the node is a hub;
exchanging the pheromone value with neighbor nodes;
comparing pheromone values received from the neighbor nodes; and
transmitting a packet to a neighbor node having the greatest pheromone value.

15. The method of claim 14, further comprising:
selecting a communication method of the node, before the determining of whether or not the node is a hub,
wherein, in the calculating of a pheromone value, a pheromone value is calculated in consideration of whether or not the node is a hub and the communication method.

16. The method of claim 15, wherein the transmitting of a packet comprises:
when the node is a source node, determining whether or not the neighbor node having the greatest pheromone value corresponds with the communication method of the node;
when the neighbor node having the greatest pheromone value does not correspond with the communication method of the node, selecting a node having a second-greatest pheromone value and performing the determination; and
when the neighbor node having the greatest pheromone value corresponds with the communication method of the node, transmitting a packet to the neighbor node having the greatest pheromone value.

17. The method of claim 15, wherein the transmitting of a packet comprises:
when the node is a forwarding node, determining whether or not the neighbor node having the greatest pheromone value corresponds with a communication method included in a reception packet;
when the neighbor node having the greatest pheromone value does not correspond with the communication method, selecting a node having the second-greatest pheromone value, and performing the determination; and
when the neighbor node having the greatest pheromone value corresponds with the communication method, routing the packet to the neighbor node having the greatest pheromone value.

18. The method of claim 14, wherein the exchanging of the pheromone value with neighbor nodes comprises:
broadcasting a hello message including the communication method of the node and the pheromone value of the node to one-hop neighbor nodes; and
receiving a hello message including a communication method and a pheromone value of each of the one-hop neighbor nodes.

19. The method of claim 18, wherein the comparing of the pheromone values received from the neighbor nodes comprises;
classifying one-hop neighbor nodes whose hello message, which has been transmitted, has a received signal strength equal to or greater than a predefined strength, among the one-hop neighbor nodes;
estimating a link connection duration with the classified one-hop neighbor nodes;
selecting the one-hop neighbor nodes whose link connection duration satisfies a predefined threshold value, as forwarding node subjects; and
comparing pheromone values of the one-hop neighbor nodes selected as the forwarding node subjects.

20. The method of claim 19, wherein the determining of whether or not the node is a hub comprises:
transmitting and receiving a packet;
updating a source address and a destination address of the transmitted or received packet in a forwarding information base (FIB), the FIB including a source address, a destination address, addresses of neighbor nodes corresponding to the source address and the destination address, neighbor node location information, neighbor node velocity information, and pheromone of a neighbor node;
when hello messages are received from one-hop neighbor nodes, determining whether or not received signal strength is equal to or greater than a predefined strength.
excluding one-hop neighbor nodes whose received signal strength is not greater than the predefined strength;
when a line connection duration with one-hop neighbor nodes having the received signal strength equal to or greater than the predefined strength satisfies the predefined threshold value, comparing path utilization frequency of the one-hop neighbor nodes with that of the node;
determining whether or not a time to live (TTL) of the transmitted or received packet satisfies a predefined average TTL; and
when the TTL of the transmitted or received packet satisfies the predefined average TTL and the path utilization frequency of the node is greater than that of the one-hop neighbor nodes, determining that the node is a hub.

21. The method of claim 20, wherein the comparing of the path utilization frequency comprises:
calculating the path utilization frequency of the node based on locations of the one-hop neighbor nodes confirmed from the hello message, the pheromone values of the one-hop neighbor nodes, and the source address and destination address storage information included in the FIB; and
comparing the path utilization frequency of the node with that of the one-hop neighbor node included in the hello message, respectively.
